(19) United States
(12) Patent Application Publication
(10) Pub. No.: US 2010/0136921 A1
(43) Pub. Date: Jun. 3, 2010

(54) INTERFACE UNIT FOR DISPLAY OF ALPHANUMERIC DATA

(75) Inventor: Franco Pedrazzi, San Paolo Solbrito (AT) (IT)

Correspondence Address: MERCHANT & GOULD PC, P.O. BOX 2903, MINNEAPOLIS, MN, 55402-0903, US

(73) Assignee: PASER S.R.L, San Paolo Solbrito (AT) (IT)

(21) Appl. No.: 12/090,341

(22) PCT Filed: Feb. 14, 2006
(86) PCT No.: PCT/EP06/01328

§ 371 Date: Apr. 15, 2008

(30) Foreign Application Priority Data
Oct. 17, 2005 (IT) AT2005A000011

(51) Int. Cl. H04B 1/00; G06F 17/00; G10L 21/00

(52) U.S. Cl. 455/68; 700/94; 704/500; 704/E21.001

(57) ABSTRACT

An interface. unit (1) for display of alphanumeric-data packets, includes an input connector and an output connector (3). The input connector (2) is connectable by a first connection to a first apparatus (11, 11′) for reproduction of an audio signal to which alphanumeric data are associated. The output connector (3) is connectable by a second connection to a second reproduction apparatus (12) having a display (13) and a telematic decoder of the data packets. The interface unit (1) further includes a treatment of the audio signal connected to the input connector (2). The treatment of the audio signal carries out a preamplification and a filtering in frequency of the audio signal. A processor (7, 8) is connected to the input connector (2). The processor (7, 8) extracts and carries out a telematic encoding of alphanumeric data. A signal-mixer unit (9) is connected to the treatment of the audio signal and to, the processor. The signal-mixer unit (9) adds the signals coming from the treatment of the audio signal and at output from the processor (7,8). A modulator (10), connects to the signal-mixer unit (9) and to the output connector (3), for modulation of the signal coming from the signal-mixer unit (9). The second reproduction apparatus (12) enables display of the alphanumeric data by the display (13).

The present invention relates to an interface unit for display of alphanumeric data.

In greater detail, the invention concerns an electronic unit that enables encoding of the data, enabling their display on apparatuses that support telematic-decoding systems.

In what follows, the description will refer to the application to a car radio, but it is evident how it is not to be considered limited to this specific use.

As is well known, there currently exist different systems for transmitting alphanumeric data encoded in a telematic way together with audio or video signals. A very widespread type is the Radio Data System (RDS).

The above system is currently integrated in almost all car radios by means of an appropriate electronic circuit or module. This is able to receive and decode a standard for transmission of appropriately encoded data.

In particular, the RDS system exploits an additional band for the transport of data, which, added to the frequency-modulation (FM) band, enables transport of the data without causing any disturbance to the audio program.

The radiodiffused telematic service RDS is based upon the use of said additional data band (having a frequency with subcarrier at 57 kHz) for the diffusion of information of various nature.

In particular, the RDS stems from the prerogative of assigning an identifier to each radio emitter, so that the RDS decoding module can recognize the station that the user is listening to, which, once tuned to, enables automatic search for the same emitter at other frequencies when the signal deteriorates in order to achieve perfect reception.

The data generally received from said system concern, for example, the name of the emitter or the title of the piece of music transmitted.

Furthermore, currently there is an ever increasing spread of audio sources or hands-free systems for cellphones or other similar devices. These frequently imply connection with the car radio installed in order to use the amplifier apparatus and diffusers thereof.

However, in said systems, whilst the audio functions are managed easily, the text data, which are frequently available and which are also of fundamental importance themselves, can be used through additional display units, and this notwithstanding the fact that the car radio already has available a viewer or display.

Currently there exist technologies that enable generation and use of data in RDS format, applied principally to the hands-free kits of cellphone apparatuses, like the one described in the patent application No. U.S. Pat. No. 6,163,711. Described in said document is an interface capable of performing a frequency modulation of a signal of a telephone call. The signal obtained is set at input to the low-power aerial connector of said car radio. Said interface also includes a processor capable of generating data channels to be transmitted together with the modulated signal.

The above system enables use of automatic-search systems for choice of the modulation channel. In other words, it carries out automatic tuning of the band pre-stored by means of the RDS system.

The problem that current systems present is that of not enabling acquisition of data information of an alphanumeric type associated to audio files in general. It is in fact known that there is an ever-increasing spread of devices that enable storage and reproduction of music files in various formats (I-POD and the like), to which, for example, names or strings of characters in general (bearing the author, name of the piece, year, etc.) or images can be associated.

In the light of what has been said above, the purpose of the present invention is to provide an interface unit capable of processing, encoding and sending text data to devices, equipped with appropriate decoding systems so that they can be displayed on a display or viewer with which they are equipped.

A further purpose of the present invention is to enable reproducers of audio files stored in the various digital formats (e.g., MP3, WMA), hands-free kits, and other sources that require a user interface to have available a real-time display of the information linked to their state of operation.

Consequently, forming a specific subject of the present invention is an interface unit for display of alphanumeric-data packets, comprising an input connector and an output connector, said input connector being connectable by means of first connection means to a first apparatus for reproduction of an audio signal to which alphanumeric data are associated, and said output connector being connectable by means of second connection means to a second reproduction apparatus comprising display means and means for the telematic decoding of said alphanumeric-data packets. Said interface unit is characterized in that it comprises: means for treatment of the audio signal, which are connected to said input connector, said means for treatment of the audio signal carrying out a pre-amplification and a filtering in frequency of said audio signal; processing means connected to said input connector, said processing means extracting and carrying out a telematic encoding of said alphanumeric data; a signal-mixer unit connected to said means for treatment of the audio signal and to said processing means, said signal-mixer unit adding the signals coming from said means for treatment of the audio signal and at output from said processing means; and modulation means, connected to said signal-mixer unit and to said output connector, for modulation of the signal coming from said signal-mixer unit; said second reproduction apparatus enabling display of said alphanumeric data by means of said display means.

Once again according to the invention, said telematic encoding of said alphanumeric data can be of an RDS (Radio Data System) type.

Once again according to the invention, said processing means can comprise a microprocessor.

Furthermore, according to the invention, said microprocessor can enable control of said first reproduction apparatus.

Once again according to the invention, said processing means can comprise a telematic unit for encoding said alphanumeric data, which is connected to said microprocessor.

Preferably, according to the invention, said means for treatment of the audio signal can comprise at least one of the following devices: a pre-amplifier, a pre-emphasis filter, a compressor, a limiter, a stereo encoder.

Once again according to the invention, the interface unit can comprise the function of search for alternative frequencies.

Advantageously according to the invention, said function of search for alternative frequencies can be controllable by means of said second reproduction apparatus.

Furthermore, according to the invention, said first audio reproduction apparatus can be a reader of audio files, such as an M-Peg 3 or WMA reader.

Preferably, according to the invention, said alphanumeric data can comprise information concerning the title of a piece of music and/or the author and/or the duration thereof.

Once again according to the invention, said first audio reproduction apparatus can be a hands-free apparatus for a cellphone apparatus.

Advantageously, according to the invention, said alphanumeric data can comprise times of conversation and/or battery state and/or telephone number of the caller and/or generic information of the hands-free menu.

Once again according to the invention, said modulation means can be of a radiofrequency type and perform a modulation on a pre-settable carrier frequency.

Once again according to the invention, said first or second connection means can be wireless ones, such as infrared transceivers.

Preferably, according to the invention, said second audio reproduction apparatus can be a car radio.

Advantageously, according to the invention, said display means can comprise a liquid-crystal viewer.

Once again according to the invention, said interface unit can comprise a supply module for stabilization of the supply.

Preferably, according to the invention, said interface unit can comprise control means, such as remote controls or radio controls.

The present invention will now be described by way of illustrative but non-limiting example, according to its preferred embodiments, with particular reference to the figures of the attached plate of drawings, in which:

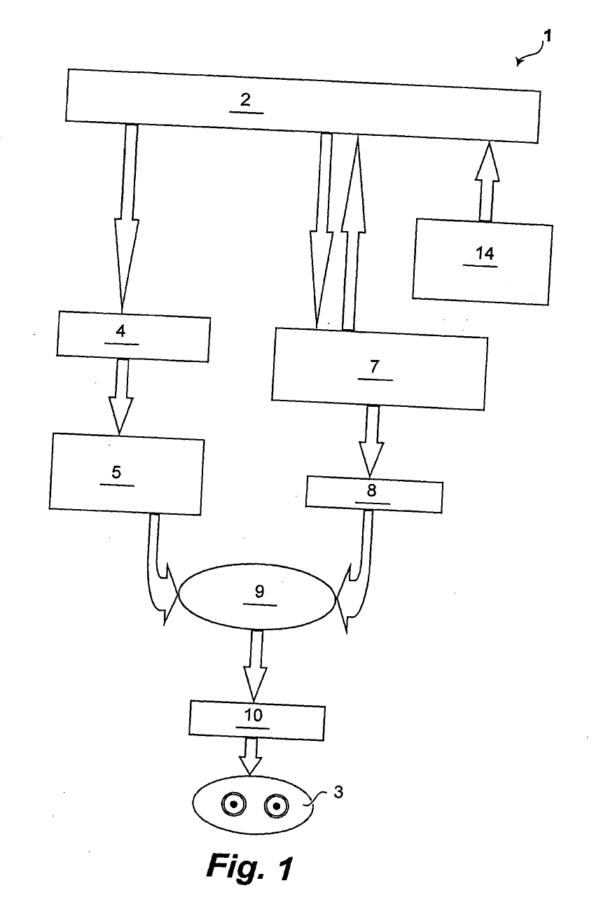

FIG. 1 shows a block diagram of operation of an interface unit for display of alphanumeric data according to the present invention;

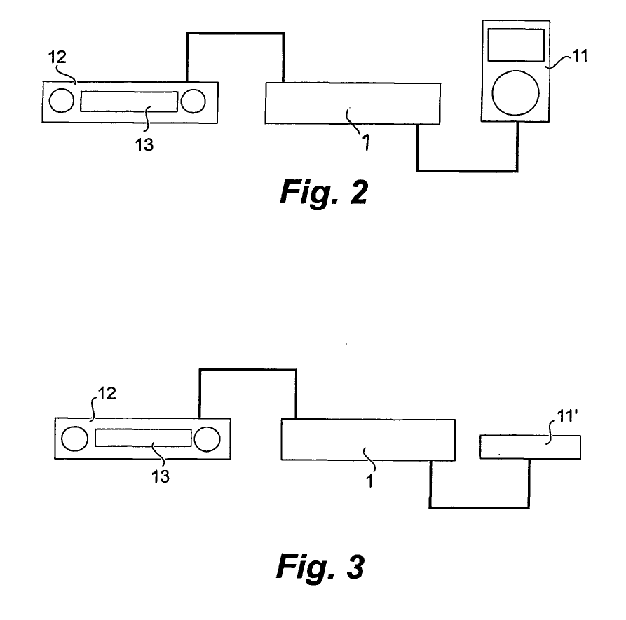

FIG. 2 shows a block diagram of the connection of the interface according to FIG. 1; and

FIG. 3 shows a second block diagram of connection of the interface according to FIG. 1.

With reference to FIG. 1, there may be noted a block diagram of the interface unit 1 for data display.

Said interface unit 1 includes a connector 2 for the input signal coming from an audio source of any nature and an output connector 3, for connection to a unit of reproduction/treatment of the signal equipped with an RDS decoding system.

Said interface unit 1 mainly comprises two channels for treatment of the input signal. The first channel includes a pre-amplifier 4 and a filtering module 5. The pre-amplifier 4 enables raising of the amplitude of the audio signal to enable treatment by the subsequent modules thereof.

The filtering module 5, on the one hand, enables limitation of the passband of the signal, avoiding acquisition of noise and, on the other hand, enables its processing to obtain appropriate audio effects. In fact, said filtering module 5 can comprise submodules, such as a pre-emphasis filter, a signal compressor, a limiter, and a stereo encoder.

The second channel for treatment of the signal comprises a microprocessor 7, cascaded to which is an RDS encoder 8.

Said microprocessor 7 is able to control simultaneously both the audio-source device (not illustrated in the figure), and the RDS encoder 8. In addition, it carries out a detection of the data to be encoded in RDS format.

The channels described above for treatment of the input signals converge into a mixer 9, which is hence able to carry out a mixing of the audio signal at output from said filtering module 5 with the RDS-encoded signal at output from said RDS encoder 8.

Finally, present downstream of said mixer 9 is a modulation unit 10, which modulates in frequency on a pre-set carrier the signal leaving the mixer 9.

When said audio source is connected to said interface unit 1, the signal coming therefrom comprises alphanumeric data. The audio part of said signal is treated, as has been seen above, and processed in a different way from the part containing alphanumeric data.

In particular, said microprocessor 7 is able to isolate and encode the signal containing said alphanumeric data. Next, the RDS encoder 8 encodes it on a standard carrier in the RDS telematic format. The signal thus obtained, once mixed again with the audio signal by means of the mixer 9, and frequency-modulated by said modulation unit 10, is sent at input to a low-power aerial connector, for example of a car radio (not illustrated in the figure). Since the latter is equipped with means for decoding signals in RDS format, it shows said alphanumeric data on the display or viewer.

Finally, said interface unit 1 comprises internally, a supply module 14, which, in addition to stabilizing the supply of the unit itself, enables recharging of the reproduction device connected at input to the connector 2.

FIG. 2 shows a diagram of connection of a player 11 of audio files, for example of an MP3 type.

Said player 11 is connected to said interface unit 1. The signal at output is set on the input connector 2.

Once the signal has been processed, said interface unit 1 sends it, RDS-encoded and frequency-modulated, at input to the radiofrequency connections of the car radio 12, which can display, as has been said above, the alphanumeric information on a viewer or display 13 associated, for example, to the piece of music being played, as if they were receiving from any radio source.

FIG. 3 shows the same connection structure as the one illustrated in FIG. 2, in which, instead of a player of MP3 files, a hands-free kit 11′ for a cellphone (not illustrated in the figure) is present.

Said interface unit 1 enables display on the viewer or display 13 of the car radio 12 information contained in the display of the cellphone, such as the times of conversation, the battery state, the phone number of the caller, or generic information of the hands-free menu.

Said interface unit 1 enables use of all of the functions connected to the RDS system, for example the function of automatic band tuning. When this function is activated on the car radio 12 and the player 11 of audio files is connected to the interface unit 1, said car radio 12 automatically carries out a search for the pre-set connection band.

A further function that can be activated is the one known as the search for the alternative frequency or RDS AF (Alternative Frequency). This enables a twin band to be found in the case where the band currently being used were disturbed.

Said interface unit 1 can also envisage a remote control or radio control (not illustrated in the figures) for control of the various functions.

The connections between said interface unit 1 forming the subject of the present invention can either be wired, as illustrated in FIGS. 2 and 3, or even employ wireless solutions, for example ones using infrared transceivers.

On the basis of the foregoing description, it may be noted that the fundamental advantage of the present invention is that of enabling display of alphanumeric information coming from any audio player, and in particular a reader/player of files.

One advantage of the present invention is that of enabling a player of MP3 files to display text data of the audio files contained in the player so as to render identifiable the piece before its reproduction has started, as well as information regarding the state of the player.

A further advantage of the present invention is to enable the use of functions proper to RDS systems.

1. An interface unit for display of alphanumeric-data packets, comprising an input connector and an output connector, said input connector being connectable by first connection means to a first reproduction apparatus of an audio signal, to which alphanumeric data are associated, and said output connector being connectable by second connection means to a second reproduction apparatus comprising display means and means for telematic decoding of said alphanumeric-data packets; said interface unit comprising:
means for treatment of the audio signal, which are connected to said input connector, said means for treatment of the audio signal carrying out pre-amplification and filtering in frequency of said audio signal;
processing means connected to said input connector, said processing means extracting and carrying out a telematic encoding of said alphanumeric data; a signal-mixer unit connected to said means for treatment of the audio signal and to said processing means, said signal-mixer unit adding the signals coming from said means for treatment of the audio signal and at output from said processing means; and
modulation means, connected to said signal-mixer unit and to said output connector, for modulation of the signal coming from said signal-mixer unit; said second reproduction apparatus enabling display of said alphanumeric data by of said display means.

2. The interface unit according to claim 1, wherein said telematic encoding of said alphanumeric data comprises Radio Data System (RDS) type or based on similar protocols, of an RDS type.

3. The interface unit according to claim 1, wherein said processing means comprise a microprocessor.

4. The interface unit according to claim 3, wherein said microprocessor enables control of said first reproduction apparatus.

5. The interface unit according to claim 3, wherein said processing means comprise a unit for telematic encoding of said alphanumeric data, which is connected to said microprocessor.

6. The interface unit according to claim 1, wherein said means for treatment of the audio signal comprise at least one of the following devices: a pre-amplifier, a pre-emphasis filter, a compressor, a limiter, a stereo encoder.

7. The interface unit according to claim 1, comprising the function of search for alternative frequencies.

8. The interface unit according to claim 7, wherein said function of search for alternative frequencies is controllable by said second reproduction apparatus.

9. The interface unit according to any claim 1, wherein said first audio reproduction apparatus is a reader of audio files.

10. The interface unit according to claim 9, wherein said files are of an M-Peg 3 or WMA type.

11. The interface unit according to claim 9, wherein said alphanumeric data comprise information selected from the group consisting of: the title of a piece of music, the author the duration.

12. The interface unit according to claim 1, wherein said first audio reproduction apparatus is a hands-free apparatus for a cellphone apparatus.

13. The interface unit according to claim 12, wherein said alphanumeric data is selected from the group consisting of times of conversation, battery state, phone number of the caller, generic information of the hands-free menu.

14. The interface unit according to claim 1, wherein said modulation means are of a radiofrequency type and perform a modulation on a pre-settable carrier frequency.

15. The interface unit according to claim 1, wherein said first or second connection means are wireless means.

16. The interface unit according to claim 15, wherein said wireless connection means comprise infrared transceivers.

17. The interface unit according to any claim 1, wherein said second audio reproduction apparatus is a car radio.

18. The interface unit according to the claim 1, wherein said display means comprise a liquid-crystal viewer.

19. The interface unit according to claim 1, comprising a supply module for the stabilization of the supply.

20. The interface unit according to claim 1, comprising control means selected from the group consisting of a knob or remote control or radio control.
